(19) United States
(12) Patent Application Publication
(10) Pub. No.: US 2008/0079809 A1
(43) Pub. Date: Apr. 3, 2008

(54) SURVEILLANCE CAMERA AND SURVEILLANCE CAMERA SYSTEM WITH LASER POSITIONING FUNCTION

(75) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: APPRO TECHNOLOGY INC., Taipei County (TW)

(21) Appl. No.: 11/556,704

(22) Filed: Nov. 6, 2006

(30) Foreign Application Priority Data
Oct. 3, 2006 (TW) 95136698

(51) Int. Cl. H04N 7/18; H04N 9/47

(52) U.S. Cl. 348/143

(57) ABSTRACT

A surveillance camera including a housing, a monitoring lens and at least a light beam sight is provided. The monitoring lens is fixed in the housing and faces a monitoring direction. The light beam sight is fixed to the housing and disposed nearby the monitoring lens. The light beam sight is adapted to emit a light beam along the monitoring direction. The light beam is adapted to provide an image fixing position for monitoring lens to fix on an image.

### CROSS-REFERENCE TO RELATED APPLICATION

This application claims the priority benefit of Taiwan application serial no. 95136698, filed Oct. 3, 2006. All disclosure of the Taiwan application is incorporated herein by reference.

### BACKGROUND OF THE INVENTION

1. Field of the Invention

The present invention generally relates to a surveillance system, and more particularly, to a surveillance system with light beam positioning function, and a surveillance camera thereof.

2. Description of Related Art

A surveillance camera is usually secured on a wall or a building, for monitoring internal public areas or surroundings of the building. Such a surveillance camera is generally employed in a surveillance system. The surveillance system generally includes a plurality of surveillance cameras, a surveillance host and a monitor. Typically, the surveillance host is electrically coupled to the surveillance cameras and the monitor. The surveillance cameras convert captured images into image signals, and transfer the image signals to the surveillance host for displaying images captured by the surveillance cameras on the monitor. In this way, guards and security service personnel are able to monitor the public areas inside/outside the building via the surveillance system.

In a conventional process for installing surveillance cameras to the building, angles and positions of the surveillance cameras are usually learnt by assistance of the monitor. Otherwise, the monitoring area cannot be figured out. Unfortunately, the monitor and the surveillance cameras are often needed to be installed apart from each other by a considerable long distance. Accordingly, an installing staff has to travel back and forth between the positions of the monitor and the surveillance cameras several times to properly adjust positions of the surveillance cameras. Thus, whole process is time-consuming and inconvenient. For monitoring a sight with an inanimate background, e.g., a whole wall of a single color or ornamented with a drab pattern, or lack of light, it is not easy for the installing staff to learn whether the focused monitoring area is exactly the required monitoring area. On the other hand, without the assistance of the monitor, installation of the surveillance cameras by eyes often causes deviation from the actual monitoring area.

### SUMMARY OF THE INVENTION

Accordingly, the present invention is directed to provide a surveillance camera. The camera has a light beam positioning function, by which the installation process can be simplified.

The present invention is also directed to provide a surveillance system including a surveillance camera. The camera has a light beam positioning function, by which the installation process can be simplified.

In the present invention, a surveillance camera is provided. The surveillance camera includes a housing, a monitoring lens, and at least a light beam sight. The monitoring lens is fixed in the housing, and is configured to monitor towards a monitoring direction. The light beam sight is fixed to the housing, and is disposed nearby the monitoring lens. The light beam sight is adapted for emitting a light beam towards the monitoring direction. The light beam is adapted for providing an image fixing position for the monitoring lens to fix on an image.

According to an embodiment of the invention, the monitoring direction is substantially parallel to the transmitting direction of the light beam.

According to an embodiment of the present invention, the light beam sight comprises a laser beam sight.

According to an embodiment of the present invention, the surveillance camera further includes a switching device fixed to the housing. The switching device includes a switching circuit and an action device, and is electrically connected to the light beam sight for turning on/off the light beam. The action device is adapted for conducting or disconnecting a power of the switching circuit.

In the present invention, a surveillance system is further provided. The surveillance system includes an aforementioned surveillance camera, a monitoring host, and a monitor. The monitoring host is electrically connected to the surveillance camera. The surveillance camera is adapted for converting captured images into image signals, and transferring the image signals to the monitoring host. The monitoring host is adapted for providing a control signal for controlling the surveillance camera. The monitor is electrically connected to the monitoring host, and is adapted to display a monitoring image thereby.

According to an embodiment of the present invention, the foregoing surveillance camera is electrically connected to the monitoring host via an intranet, internet, or a wireless network.

According to an embodiment of the present invention, the foregoing surveillance system further includes a data storage apparatus. The data storage apparatus is electrically connected to the monitoring host, and is adapted for storing the image signals as image data.

In summary, the surveillance camera in accordance with the present invention employs a light beam sight disposed nearby a monitoring lens. The light beam sight emits a light beam for providing an image fixing position for the monitoring lens to fix on the image. Therefore, the surveillance camera can be accurately and conveniently installed to an optimal position with an optimal installing angle without facilitation of a monitor.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a surveillance camera fixed to an object, according to an embodiment of the present invention.

FIG. 2 is a block diagram illustrating a surveillance system, according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

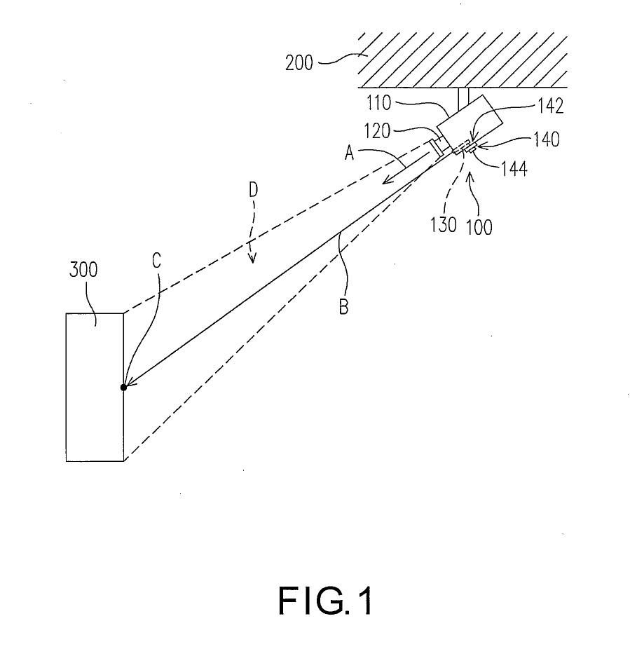

FIG. 1 is a schematic diagram illustrating a surveillance camera fixed to an object, according to an embodiment of the present invention. Referring to FIG. 1, a surveillance camera 100 of the present embodiment is adapted to be installed onto an object 200. The object 200 for example can be a building, a wall, a ceiling, a post, a ground, or anything suitable for supporting the surveillance camera 100. In this preferred embodiment, the object 200 is exemplified as a ceiling. The surveillance camera 100 includes a housing 110, a monitoring lens 120, and a light beam sight 130.

The monitoring lens 120 is fixed to the housing 110, and is configured to monitoring toward a monitoring direction “A”. The light beam sight 130 is fixed to the housing 110, and is disposed nearby the monitoring lens 120. The light beam sight 130 is adapted for emitting a light beam “B” transmitting along the monitoring direction “A”. The light beam “B” is adapted for providing an image fixing position “C” for the monitoring lens 120 to fix on an image. In details, according to the present embodiment, the monitoring direction “A” is substantially parallel with the transmitting direction of the light beam “B”. The light beam “B” can be projected to the image fixing position “C” of a reference object 300 and configures a light dot on the reference object 300, the image fixing position “C” being aimed by the monitoring lens 120. The reference object 300 for example is a wall, a ceiling, furniture, an ornament, a human being, an animal, a plant, or any object allowing the light beam “B” to configure a light dot thereon. Therefore, the surveillance camera 100 is capable of monitoring images within a monitoring area centered by a line connecting the image fixing position “C” and the monitoring lens 120. The monitoring area “D” can be enlarged or narrowed in accordance with the change of the zooming rate of the monitoring lens 120. However, it is to be noted that in other embodiments of according to the present invention, the monitoring direction “A” can also be not parallel with the transmitting direction of the light beam “B”. Similarly, the surveillance camera 100 can also include more than one light beam sight 130, for providing optimal image fixing position “C” or multiple image fixing positions “C”.

In the present embodiment, the light beam sight 130 is a laser sight, and the light beam “B” is a laser correspondingly emitted from the laser sight. However, in other embodiments according to the present invention, the light beam sight can also be any other light source capable of configuring a light dot, a light spot or light dispersion pattern on an object.

The surveillance camera 100 of the present embodiment further includes a switching device 140 fixed to the housing 110. The switching device 140 includes a switching circuit 142 and an action device 144. The switching circuit 142 is electrically connected to the light beam sight 130 for turning on/off the light beam “B”. The action device 144 is adapted for being applied with a force to conduct or disconnect a power of the switching circuit 142. For example, when the action device 144 is applied with a force to conduct the power of the switching circuit 142, the switching circuit 142 turns on the light beam “B“; and when the action device 144 is applied with another force to disconnect the power of the switching circuit 142, the switching circuit 142 turns off the light beam “B”. The action device 144 for example is a button, a knob, a control stick, or any element adapted for being applied with a force to turn on/off the switching circuit 142. As shown in FIG. 1, the action device 144 is a button, adapted for conducting or disconnecting the power of the switching circuit 144 when being pressed. However, in other embodiments according to the present invention, the function of turning on/off the light beam “B”, can be integrated to other operational elements or interfaces of the surveillance camera 100, with other functions of the surveillance camera 100.

To install the surveillance camera 100 to the object 200, the light beam sight 130 is turned on. For example, an installing staff may apply a force on the action device 144 to conduct the switching circuit 142 to turn on the light beam “B”. Then, the installing staff changes the angle of the surveillance camera 100, or shifts the position of the surveillance camera 100, while observing changes of the position of the light dot. When the light dot is observed to be on the image fixing position “C” of the reference object 300 for positioning of the surveillance camera 100, the surveillance camera 100 can be fixed to the object 200. In such a way, the surveillance camera 100 can be installed accurately, quickly and conveniently, to an optical position and optimal angle, without facilitation of a monitor.

It is to be noted that if the reference object 300 has an inanimate outlook, e.g., a whole wall of a single color or ornamented with a drab pattern, or the environment lacks of light, the surveillance camera 100 can still be positioned by the light dot projected on the reference object 300, while conventional surveillance camera suffers difficulties for installment under such conditions. Specifically, in the present embodiment, the light beam “B” provided thereby is a laser beam that does not diffuse. Therefore, the light beam sight 130 can obtain clear light dot on the reference object 300 for the surveillance camera 100 to fix on an image, even in a relatively dark environment.

Furthermore, the above illustrated surveillance camera 100 is also adapted for using in a surveillance system that is to be exemplified with embodiments below.

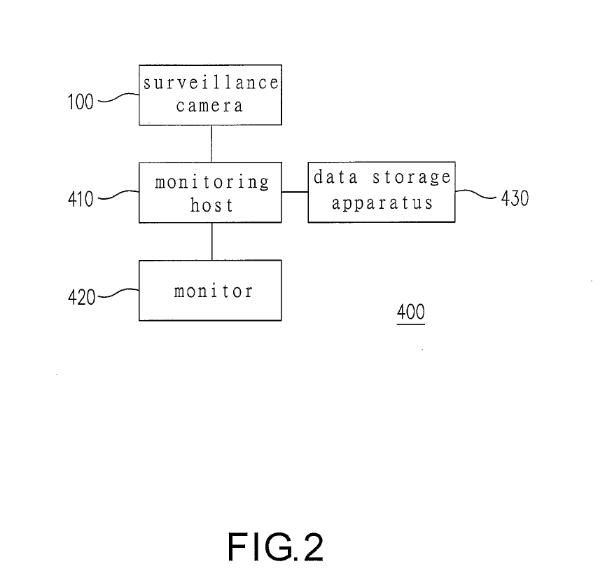

FIG. 2 is a block diagram illustrating a surveillance system, according to an embodiment of the present invention. Referring to FIG. 2, a surveillance system 400 includes a surveillance camera 100, which has been illustrated in the aforementioned embodiments, a monitoring host 410, and a monitor 420. The monitoring host 410 is electrically connected to the surveillance camera 100. The surveillance camera 100 is adapted for converting captured images into an image signal, and transferring the image signal to the monitoring host 410. The monitoring host 410 is adapted for providing a control signal for controlling the surveillance camera 100. The monitor 420 is electrically connected to the monitoring host 410, and is adapted to display a monitoring image thereby. For example, the monitoring host 410 can adjust the focus and/or the monitoring direction “A” of the surveillance camera 120 by transmitting the control signal to the surveillance camera 100 (referring to FIG. 1).

However, it is to be noted that the quantity of the surveillance camera 100 and the monitor 420 of the surveillance system 400 is not limited or exclusively defined by the present invention. In other embodiments according to the present invention, more than one surveillance camera 100, and/or more than one monitor 420 can be employed. Multiple monitors 420 are suitable for displaying images obtained by different surveillance cameras 100. In another hand, a single monitor 420 also can display images obtained from different surveillance cameras 100 by partitioning the displaying area thereof.

According to the present embodiment, the monitoring host 410 of the surveillance system 400 for example is a computer, while the surveillance camera 100 is electrically connected to the monitoring host 410 via an intranet, internet, or a wireless network. Such a surveillance system 400 is often called a digital network surveillance system. Further, the surveillance system 400 can further include a data storage apparatus 430. The data storage apparatus 430 is electrically connected to the monitoring host 410, and is adapted for storing the image signals as image data. For example, the data storage apparatus 430 is a hard disk machine, a soft disk machine, a video recorder, an optical disk burner, or any other suitable data storage apparatus, for allowing the image signals stored therein. Furthermore, the data storage apparatus 430 can also convert stored image data into image signals, and transmit the image signal to the monitoring host 410, by which the monitor 420 can display the image thereof.

In other embodiments according to the present invention, the monitoring host 410 and the data storage apparatus 430 can also be integrated as a digital network video recorder (DNVR). However, the present invention does not limit the surveillance camera 100 as connecting to the monitoring host 410 via a network. Normal circuits can also be used to electrically connect the surveillance camera 100 with the monitoring host 410.

In summary, the surveillance camera in accordance with the present invention employs a light beam sight disposed nearby a monitoring lens. The light beam sight emits a light beam for providing an image fixing position for the monitoring lens to fix on a image. Therefore, the surveillance camera can be accurately, quickly and conveniently installed to an optimal position with an optimal installing angle without facilitation of a monitor. Moreover, the surveillance camera according to the present invention can be employed in almost all kinds of surveillance systems, and the efficiency of installing the surveillance system thereof can be well enhanced thereby.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A surveillance camera comprising:
a housing;
a monitoring lens fixed in the housing, and configured to monitoring toward a monitoring direction; and
at least one light beam sight fixed to the housing, and disposed nearby the monitoring lens, wherein the light beam sight is adapted for emitting a light beam transmitting along the monitoring direction, the light beam being adapted for providing an image fixing position for the monitoring lens to fix on an image.

2. The surveillance camera according to claim 1, wherein the monitoring direction is substantially parallel with the transmitting direction of the light beam.

3. The surveillance camera according to claim 1, wherein the light beam sight is a laser sight.

4. The surveillance camera according to claim 1, further comprising a switching device fixed to the housing, the switching device comprising:
a switching circuit electrically connected to the light beam sight, for turning on/of the light beam; and
an action device adapted for being applied with a force to conduct or disconnect a power of the switching circuit.

5. A surveillance system comprising:
at least one surveillance camera, the surveillance camera comprising:
a housing;
a monitoring lens fixed in the housing, and configured to monitoring toward a monitoring direction; and
at least one light beam sight fixed to the housing, and disposed nearby the monitoring lens, wherein the light beam sight is adapted for emitting a light beam transmitting along the monitoring direction, the light beam being adapted for providing an image fixing position for the monitoring lens to fix on an image; and
a monitoring host, electrically connected to the surveillance camera, wherein the surveillance camera is adapted for converting the image into an image signal, and transferring the image signal to the monitoring host, and the monitoring host is adapted for providing a control signal for controlling the surveillance camera; and
a monitor electrically connected to the monitoring host, for displaying a monitoring image.

6. The surveillance system according to claim 5, wherein the monitoring direction is substantially parallel with the transmitting direction of the light beam.

7. The surveillance system according to claim 5, wherein the light beam sight is a laser sight.

8. The surveillance system according to claim 5, further comprising a switching device fixed to the housing, the switching device comprising:
a switching circuit electrically connected to the light beam sight, for turning on/of the light beam; and
an action device adapted for being applied with a force to conduct or disconnect a power of the switching circuit.

9. The surveillance system according to claim 5, wherein the surveillance camera is electrically connected to the monitoring host via an intranet, internet, or a wireless network

10. The surveillance system according to claim 5, further comprising a data storage apparatus electrically connected to the monitoring host, and adapted for storing the image signal as image data.
